(19) United States
(12) Patent Application Publication
(10) Pub. No.: US 2011/0177780 A1
(43) Pub. Date: Jul. 21, 2011

(54) WIRELESS COMMUNICATION APPARATUS

(75) Inventors: Hiroto SATO, Tokyo (JP); Shoko Oguchi, Tokyo (JP)

(73) Assignee: KABUSHIKI KAISHA TOSHIBA, Tokyo (JP)

(21) Appl. No.: 12/857,830

(22) Filed: Aug. 17, 2010

(30) Foreign Application Priority Data
Jan. 15, 2010 (JP) P2010-007027
Jan. 15, 2010 (JP) P2010-007099

(51) Int. Cl. H04B 5/06

(52) U.S. Cl. 455/41.1

(57) ABSTRACT

According to one embodiment, a wireless communication apparatus includes: a first communication module configured to communicate with a counterpart apparatus; a plurality of other communication modules configured to take over a communication with the counterpart apparatus from the first communication module; a power state storage module configured to store power states of the plurality of other communication modules; and a controller configured to confirm the power states when one of the plurality of other communication modules takes over the communication from the first communication module. The controller is configured to transmit, to the counterpart apparatus through the first communication module, a request for taking over the communication to the one of the plurality of other communication modules if the power state of the one of the plurality of other communication modules is ON.

### CROSS REFERENCE TO RELATED APPLICATION(S)

The present disclosure relates to the subject matters contained in Japanese Patent Application No. 2010-007027 filed on Jan. 15, 2010, and Japanese Patent Application No. 2010-007099 filed on Jan. 15, 2010, which are incorporated herein by reference in its entirety.

### FIELD

Embodiments, described herein relate generally to a wireless communication apparatus.

### BACKGROUND

In recent years, an electronic apparatus such as a cellular phone or a PC has a plurality of wireless communication functions, for example, Bluetooth (registered trademark), wireless LAN and Near Field Communication (NFC). In the electronic apparatus, there is a technique of Connection Handover (hereinafter referred to as a handover) for enabling a communication at a longer distance than that in a close wireless communication method such as the Bluetooth or the wireless LAN by using a close wireless communication method such as NFC, exchanging set information about a communication method at a comparatively high speed to execute an authentication processing and taking over a communication to the Bluetooth or the wireless LAN in order to communicate data (for example, see JP-A-2008-160856 and Connection Handover 1.1 (NFC Forum™).).

In a specification of the handover defined in the Connection Handover 1.1 (NFC Forum™), a method of Negotiated Handover is disclosed as a handover method for taking over a communication to another high speed standard by using NFC. In the Negotiated Handover, at least one of communication standards (Alternative Carriers) of a handover destination is specified through a terminal called “Requester” for giving a request for the handover to a counterpart apparatus. The Requester can give a notice of a power state of the handover destination to a counterpart apparatus called “Selector” together with information indicative of the handover destination thus specified. The power state of the handover destination is classified into four states including a power ON state (active), a power ON processing state (activating), a power OFF state (inactive) and an unknown state (unknown). One of the states is specified and a notice thereof is given to the counterpart apparatus. On the other hand, the Selector receiving the request from the Requester selects at least one of the handover destination or more of which notice is received from the Requester and gives a notice of the power state of the handover destination to the Requester together with information indicative of the handover destination thus selected.

FIG. 5 shows an example in which the handover from the NFC to the Bluetooth is carried out. Two wireless communication apparatuses corresponding to the NFC are caused to approach a range in which an NFC communication can be performed so that the NFC communication is established, and a handover request is then transmitted from the Requester to the Selector. In the example of FIG. 5, Bluetooth is specified as the handover destination and a power supply of the Bluetooth is ON for the handover request, and the Bluetooth is selected as the handover destination and the power supply of the Bluetooth is ON for a response to be transmitted by the Selector for the handover request. By using the handover request/response, furthermore, it is possible to give a notice of an address of the Bluetooth selected as the handover destination, a type of a device and a hash or a random value which is to be used for pairing. By utilizing the information, therefore, it is possible to carry out the pairing for the Bluetooth between the Requester and the Selector. After the pairing is completed, a data communication through the Bluetooth can be carried out.

Although the Bluetooth is specified as the handover destination through the Requester in the example, it is also possible to specify, as the handover destination, wireless LAN in addition to the Bluetooth. In other words, information about the handover destination to be given to the Selector based on the handover request has three possibilities of (Bluetooth), (wireless LAN) and (Bluetooth and wireless LAN). In the case in which a plurality of handover destinations can be specified, thus, there is no mechanism for making a decision for specifying the handover destination at the Requester side in JP-A-2008-160856 and Connection Handover 1.1 (NFC Forum™). For this reason, the decision of the handover destination depends on the Selector, that is, the Requester gives the Selector a notice of communicating means capable of carrying out a handover so that the handover destination is determined based on the decision of the Selector.

Moreover, there is a technique for releasing a Bluetooth connection or a wireless LAN connection to a device which is being connected through the Bluetooth or the wireless LAN when detecting the device through a close wireless communication (for example, see JP-T-2009-521162).

However, in the case in which a Bluetooth connection to a second device is to be carried out in a state of a connection to a first device through Bluetooth, for example, it is necessary to perform a user operation for releasing the connection to the first device and to then execute a user operation for establishing a connection to the second device, resulting in a complicated operation in the invention described in JP-T-2009-521162.

### SUMMARY OF INVENTION

According to a first aspect of an embodiment, a wireless communication apparatus comprising:

a first communication module configured to communicate with a counterpart apparatus;

a plurality of other communication modules configured to take over a communication with the counterpart apparatus from the first communication module;

a power state storage module configured to store power states of the plurality of other communication modules; and

a controller configured to confirm the power states when one of the plurality of other communication modules takes over the communication from the first communication module,

wherein the controller is configured to transmit, to the counterpart apparatus through the first communication module, a request for handing over the communication to the one of the plurality of other communication modules if the power state of the one of the plurality of other communication modules is ON.

According to a second aspect of an embodiment, a wireless communication apparatus comprising:

a first wireless communication module configured to perform a first wireless communication;

a second wireless communication module configured to perform a second wireless communication which is different from the first wireless communication; and

a controller configured to communicate with a second counterpart apparatus by the first wireless communication while the wireless communication apparatus is connected with a first counterpart apparatus by the second wireless communication, and to receive second identifying information about the second wireless communication of the second counterpart apparatus,

wherein the controller is configured to release a connection of the second wireless communication to the first counterpart apparatus if the second identifying information is different from first identifying information about the second wireless communication of the first counterpart apparatus.

According to a third aspect of an embodiment, a wireless communication apparatus comprising:

a first wireless communication module configured to perform a first wireless communication;

a second wireless communication module configured to perform a second wireless communication which is different from the first wireless communication;

a storage module configured to store second identifying information about the second wireless communication by matching the second identifying information with first identifying information about the first wireless communication of a second counterpart apparatus; and

a controller configured to communicate with the second counterpart apparatus through the first wireless communication module while the wireless communication apparatus is connected with a first counterpart apparatus by the second wireless communication, and to receive the second identifying information of the second counterpart apparatus,

wherein the controller is configured to release a connection of the second wireless communication to the first counterpart apparatus if the second identifying information is different from third identifying information about the second wireless communication of the first counterpart apparatus.

### BRIEF DESCRIPTION OF THE DRAWINGS

A general configuration that implements the various feature of the invention will be described with reference to the drawings. The drawings and the associated descriptions are provided to illustrate embodiments of the invention and not to limit the scope of the invention.

FIG. 1 is a block diagram showing a configuration of a mobile phone according to a first embodiment.

FIG. 2 is a flowchart showing a processing to be executed when the mobile phone generates a handover request corresponding to a power state of Bluetooth.

FIG. 3 is a diagram showing an example of a user interface which is to be displayed on a display module in order for the mobile phone to select communication means to be a handover destination.

FIG. 4 is a sequence diagram showing a processing to be executed in the case in which a power supply of the Bluetooth is ON in the mobile phone.

FIG. 5 is a diagram showing a summary of a processing to be executed when a communication between terminals is subjected to a handover from NFC to the Bluetooth.

FIG. 6 is a block diagram showing a configuration of a mobile phone according to a second embodiment of the invention.

FIG. 7 is a flowchart representing an example of a processing of the mobile phone.

FIG. 8 is a sequence diagram showing an example of a specific processing of the mobile phone.

FIG. 9 is a flowchart showing an example of a processing of the mobile phone.

### DETAILED DESCRIPTION

In general, according to one embodiment, a wireless communication apparatus includes: a first communication module configured to communicate with a counterpart apparatus; a plurality of other communication modules configured to take over a communication with the counterpart apparatus from the first communication module; a power state storage module configured to store power states of the plurality of other communication modules; and a controller configured to confirm the power states when one of the plurality of other communication modules takes over the communication from the first communication module. The controller is configured to transmit, to the counterpart apparatus through the first communication module, a request for taking over the communication to the one of the plurality of other communication modules if the power state of the one of the plurality of other communication modules is ON.

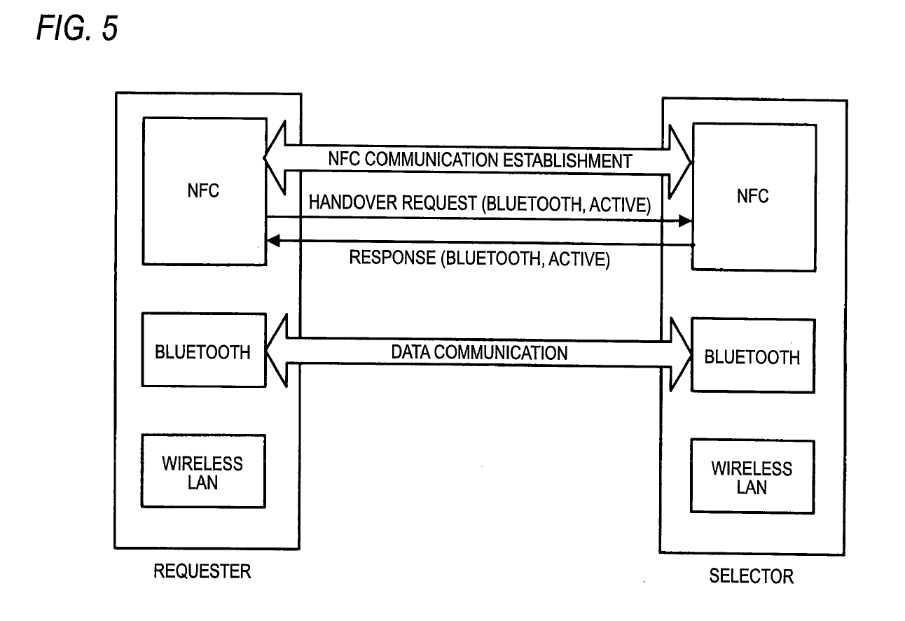

A first embodiment will be described below with reference to the drawings. A wireless communication apparatus according to the first embodiment may has a plurality of wireless communication means, and it is possible to suppose that the wireless communication apparatus is a mobile phone, a smart phone or a PC, for example. In the following description, the mobile phone will be taken as an example. The description will be given on the assumption that the mobile phone is an apparatus for transmitting a handover request to a counterpart apparatus, for example, Requester shown in FIG. 5 and can carry out a communication through NFC, Bluetooth or wireless LAN.

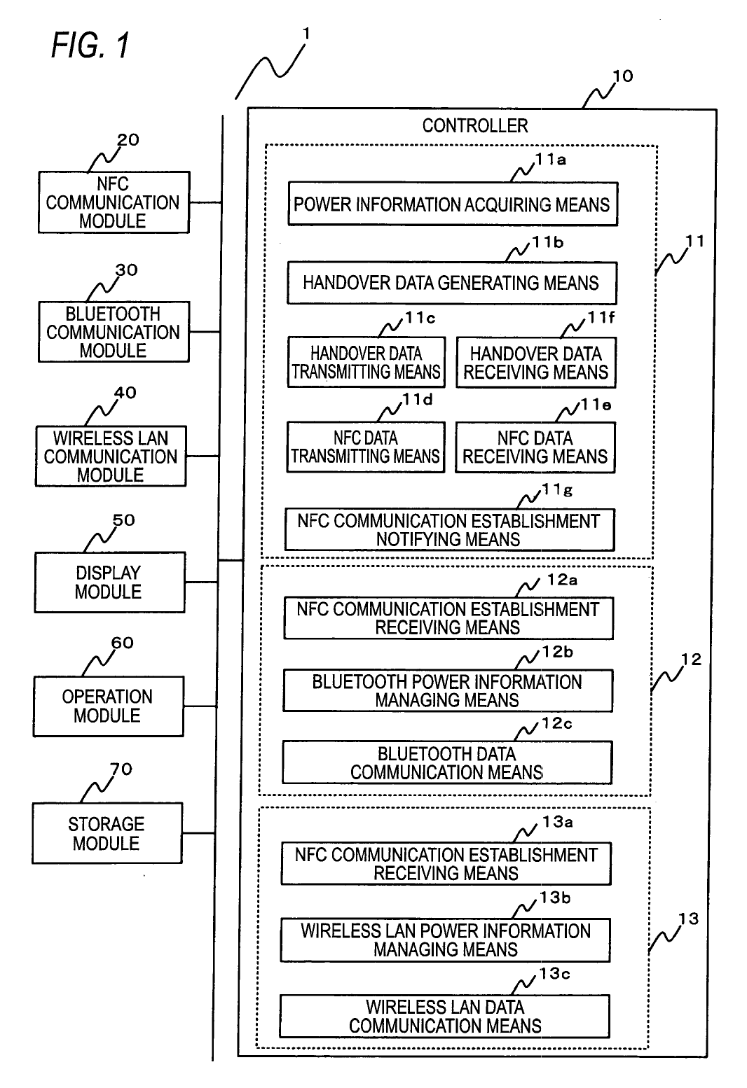

FIG. 1 is a block diagram showing a configuration of the mobile phone according to the first embodiment. A mobile phone 1 includes a controller 10 for controlling the whole mobile phone 1, and an NFC communication module 20, a Bluetooth communication module 30, a wireless LAN communication module 40, a display module 50, an operation module 60 and a storage module 70 which are controlled by the controller 10. The mobile phone 1 also includes a communication module (not shown) having an antenna for carrying out a communication with a base station accommodated in a public telephone network, and a speaker and a microphone (not shown) which are to be used for a voice communication.

The NFC communication module 20 is provided with physical NFC wireless communication means such as an antenna for an NFC communication and carries out the NFC communication based on control of the controller 10. The Bluetooth communication module 30 is provided with physical Bluetooth wireless communication means such as an antenna for a Bluetooth communication and carries out the Bluetooth communication based on the control of the controller 10. The wireless LAN communication module 40 is provided with physical wireless LAN wireless communication means such as an antenna for a wireless LAN communication and carries out the wireless LAN communication based on the control of the controller 10. The display module 50 is provided with an LCD or an organic EL display and displays a character or an image on a screen based on the control of the controller 10. The operation module 60 is provided with a key or a touch sensor, and accepts an input operation from a user and transmits the input content to the controller 10. The storage module 70 stores various applications and data to be used in the mobile phone 1.

The controller 10 has NFC communication control means 11, Bluetooth communication control means 12 and wireless LAN communication control means 13 in order to implement a handover from the NFC communication to another communicating means.

The NFC communication control means 11 includes power information acquiring means 11a as means to be used for a handover processing from the NFC communication to another communicating means, handover data generating means 11b, handover data transmitting means 11c, NFC data transmitting means 11d, NFC data receiving means 11e, handover data receiving means 11f, and NFC communication establishment notifying means 11g. The power information acquiring means 11a acquires power information about wireless communication means (for example, Bluetooth) which can be specified as a handover destination. The handover data generating means 11b generates a handover request based on a standard related to a handover from NFC to another wireless communication means. The handover data transmitting means 11c transmits the handover request generated by the handover data generating means 11b to a counterpart apparatus through the NFC communication module 20. The NFC data transmitting means 11d transmits data which can be transmitted to the counterpart apparatus through an NFC wireless communication in addition to the handover request generated by the handover data generating means 11b. The NFC data receiving means 11e receives data transmitted from the counterpart apparatus through the NFC wireless communication. The handover data receiving means 11f receives the handover request from the data received by the NFC data receiving means 11e. The NFC communication establishment notifying means 11g gives a notice that the NFC communication with the counterpart apparatus is established to at least one of the Bluetooth communication control means 12 and the wireless LAN communication control means 13.

The Bluetooth communication control means 12 includes NFC communication establishment receiving means 12a, Bluetooth power information managing means 12b and Bluetooth data communication means 12c as means for carrying out the handover from the NFC communication. The NFC communication establishment receiving means 12a receives a notice from the NFC communication establishment notifying means 11g when an NFC communicating link is established. The Bluetooth power information managing means 12b manages an ON/OFF state of the Bluetooth.

The wireless LAN communication control means 13 includes NFC communication establishment receiving means 13a, wireless LAN power information managing means 13b and wireless LAN data communication means 13c as means for carrying out the handover from the NFC communication. The NFC communication establishment receiving means 13a receives the notice from the NFC communication establishment notifying means 11g when the NFC communicating link is established. The wireless LAN power information managing means 13b manages an ON/OFF state of the wireless LAN.

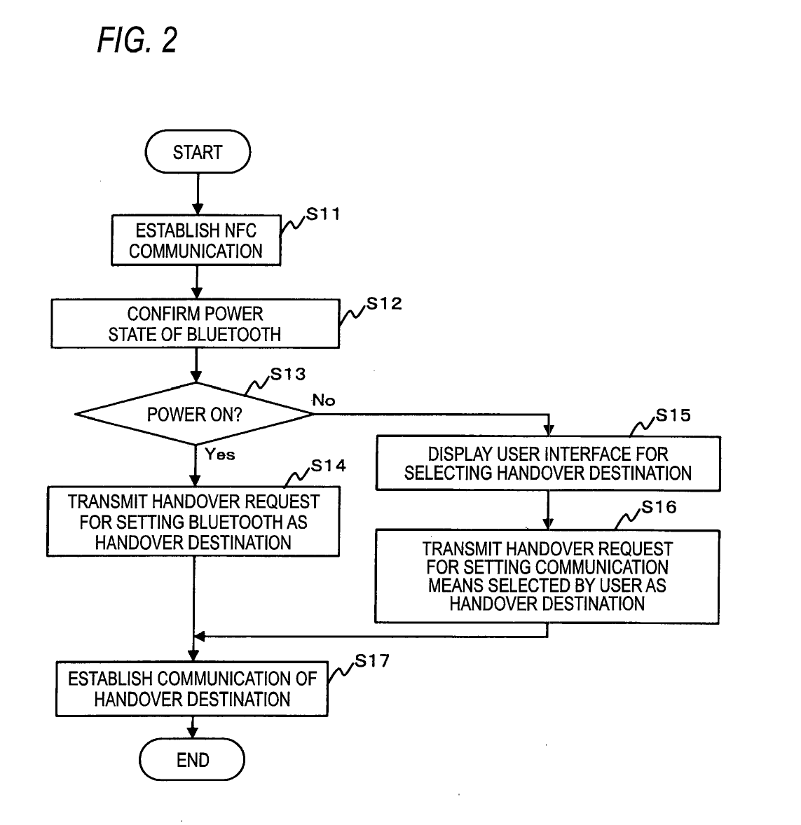

With reference to a flowchart of FIG. 2, description will be given to a processing to be executed by the controller 10 in the case in which the mobile phone 1 having the structure described above generates a handover request corresponding to a power state of Bluetooth.

The mobile phone 1 establishes an NFC communication between the mobile phone 1 and a counterpart apparatus corresponding to the NFC communication when a distance from the counterpart apparatus approximates to a given value or less (Step S11). Since the NFC communication has been described in JP-A-2008-160856, detailed description will be omitted.

The mobile phone 1 establishing the NFC communication with the counterpart apparatus acquires the power state of the Bluetooth from the Bluetooth power information managing means 12b by the power information acquiring means 11a (Step S12), and decides whether the power supply of the Bluetooth is set into an ON state or not (Step S13). If the power state of the Bluetooth is ON (Yes in Step S13), a handover request for setting the Bluetooth to be a handover destination is generated by the handover data generating means 11b and is transmitted to the counterpart apparatus (Step S14) and a Bluetooth connection to the counterpart apparatus is established (Step S17).

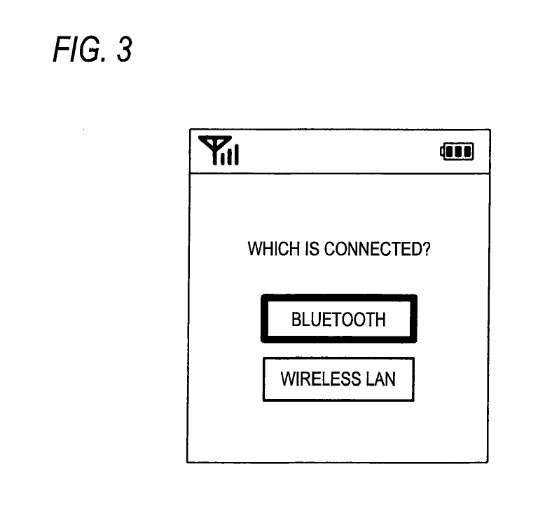

On the other hand, if the power state of the Bluetooth which is acquired from the Bluetooth power information managing means 12b by the power information acquiring means 11a is not ON (No in Step S13), a user interface for selecting communicating means to be a handover destination is displayed on the display module 50 (Step S15). FIG. 3 shows an example of the user interface to be displayed on the display module 50 in order to select the communication means to be the handover destination. In case of the mobile phone 1, the communication means capable of being selected as the handover destination includes the Bluetooth and wireless LAN. Therefore, a user interface for selecting one of the two communicating means is displayed on the display module 50 and a user selecting operation is accepted by the operation module 60. The selecting operation accepted by the operation module 60 is transferred to the controller 10. Then, the controller 10 generates a handover request for setting, as the handover destination, communication means selected by a user through the handover data generating means 11b and transmits the handover request to the counterpart apparatus (Step S16), and a communication through the communication means selected by the user is established (Step S17).

By the processing described above, it is possible to decide the communication means to be the handover destination based on an apparatus to be a handover request source, and to transmit, to the counterpart apparatus, a handover request for setting the Bluetooth as the handover destination without receiving the user selecting operation if the power supply of the Bluetooth is set into the ON state. Therefore, it is possible to relieve a burden on the user operation.

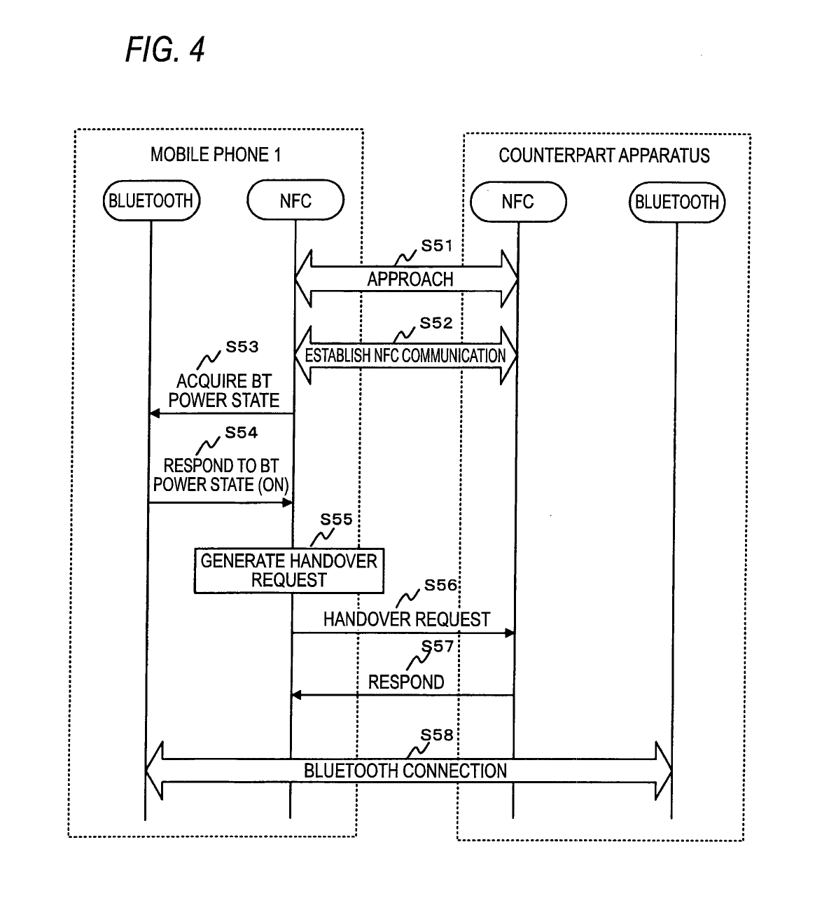

FIG. 4 is a sequence diagram showing a processing to be executed in the case in which the power supply of the Bluetooth is ON in the mobile phone 1 for determining the handover destination corresponding to the power state of the Bluetooth. When the mobile phone 1 is caused to approach a range in which an NFC communication with a counterpart apparatus can be carried out (Step S51), the NFC communication is established (Step S52). When the power state of the Bluetooth is ON (Step S53, Step S54), then, a handover request for setting the Bluetooth as the handover destination is generated (Step S55) and the handover request thus generated is transmitted to the counterpart apparatus through the NFC communication (Step S56). When a response indicating that the Bluetooth is ON is received from the counterpart apparatus for the handover request (Step S57), a connection to the counterpart apparatus is carried out through the Bluetooth (Step S58). If there is set a state in which the Bluetooth of the counterpart apparatus cannot be utilized (a notice indicating that the power state of the Bluetooth is inactive is received) at the Step S57, it is also possible to give a request for turning ON the power supply of the Bluetooth from the mobile phone 1 side to the counterpart apparatus. As shown in FIG. 4, a user operation includes only an operation for causing the mobile phone 1 to approach the counterpart apparatus at the Step S51. By carrying out a simple operation for the user, therefore, it is possible to implement a handover from the NFC communication to the Bluetooth.

For example, in a case that a mobile phone 1 is connected to an apparatus (for example, a headset) through the Bluetooth, if the Bluetooth connection is released and a Bluetooth connection to another apparatus (for example, a PC) capable of performing an NFC communication is intended to be established, the power supply of the Bluetooth on the mobile phone 1 is set into the ON state. For this reason, even if an operation for specifying the Bluetooth as the handover destination is not received from the user when the Bluetooth connection to the other apparatus is established, it is possible to implement a handover to the Bluetooth after establishing the NFC communication by causing the mobile phone 1 to approach a distance at which the NFC communication to the other apparatus can be performed.

For example, if the Bluetooth connection is released for some reason in the connection of the mobile phone 1 to a counterpart apparatus capable of performing the NFC communication through the Bluetooth, the power supply of the Bluetooth on the mobile phone 1 is set into the ON state. By causing the mobile phone 1 to approach a distance at which the NFC communication with the counterpart apparatus can be performed, therefore, it is possible to implement a handover to the Bluetooth after establishing the NFC communication. Thus, it is possible to carry out a reconnection after a Bluetooth disconnection without a user indicating operation. Consequently, it is possible to quickly carry out the Bluetooth reconnection.

Although the description has been given to the case in which the handover request for setting the Bluetooth as the handover destination is transmitted to the counterpart apparatus when the power supply of the Bluetooth is ON in the flowchart of FIG. 2, the communication means for confirming the power state at the Steps S12 and S13 is not limited to the Bluetooth but another communication means (for example, wireless LAN) possessed by the mobile phone 1 may be used. In the case in which a power state of the wireless LAN is confirmed, it is confirmed whether a power supply of the wireless LAN is set into an ON state or not at the Step S13. If the power supply of the wireless LAN is set into the ON state, a handover request for setting the wireless LAN as a handover destination is transmitted to a counterpart apparatus at the Step S14 and a communication through the wireless LAN is established at the Step S17.

Although the description has been given on the assumption that the power state of the single communication means (Bluetooth) is confirmed in the flowchart of FIG. 2, moreover, it is also possible to confirm the power states of a plurality of communication means. For example, the power state of the Bluetooth is confirmed at Step S13, and the power state of the wireless LAN may be confirmed if the power state of the Bluetooth is not ON. In this case, a handover request for setting the wireless LAN as a handover destination is transmitted to the counterpart apparatus if the power state of the Bluetooth is not ON but that of the wireless LAN is ON, and a user interface for selecting the handover destination is displayed if the power state of the Bluetooth is not ON and that of the wireless LAN is also not ON.

For example, moreover, the power state of the Bluetooth and that of the wireless LAN are confirmed at Step S13, after that, if one of the power states is ON, the communication means having the power state set into ON is selected as the handover destination. On the other hand, if both of the power states are ON, one of the communication means is selected as the handover destination depending on an application which is being activated.

In order to select the communication means depending on the application which is being activated, information for identifying the application and information for identifying the communication means having a high possibility of use in the activation of the application are matched and stored in the storage module 70 in advance. For example, in the case in which an application for playing back music is used, it can be supposed that there is a high possibility of a transfer of the music to be played back to a headset through the Bluetooth. Moreover, it can be supposed that there is a high possibility of a receipt of Web data through a wireless LAN communication with an access point of the wireless LAN when a Web browser is being activated. Therefore, information for identifying an application for playing back the music and indentifying information indicative of the Bluetooth are related to each other and information for identifying the Web browser and identifying information indicative of the wireless LAN are related to each other, thereby to be stored in the storage module 70. By confirming power states of a plurality of wireless communication means, thus, it is possible to further reduce a possibility that a user operation for selecting the communication means to be a handover destination might be generated.

According to the first embodiment, it is possible to decide the communication means to be the handover destination when giving the request for the handover from the communication means which is first connected (for example, the NFC communication) to another communication means (for example, the Bluetooth or the wireless LAN), and furthermore, to relieve a time and labor of a user which is caused in the decision of the communication means to be the handover destination.

A second embodiment will be described below with reference to the drawings. In the second embodiment, a mobile phone is used as an example of a wireless communication apparatus. The wireless communication apparatus may have a plurality of wireless communication means, and the wireless communication apparatus may be an apparatus such as a smart phone or a PC, for example.

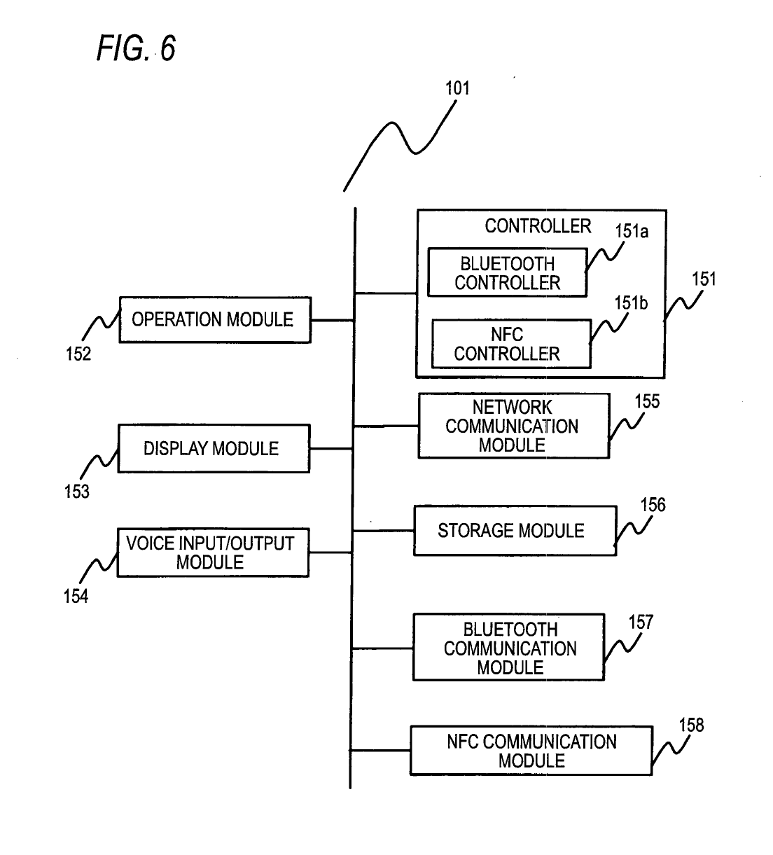

FIG. 6 is a block diagram showing a configuration of the mobile phone according to the second embodiment. A mobile phone 101 is provided with a controller 151, an operation module 152, a display module 153, a voice input/output module 154, a network communication module 155, a storage module 156, a Bluetooth communication module 157 and an NFC communication module 158.

The controller 151 is provided with a CPU and executes a general application for the mobile phone 101. Moreover, the controller 151 has a Bluetooth controller 151a for controlling the Bluetooth communication module 157 and an NFC controller 151b for controlling the NFC communication module 158.

The operation module 152 is provided with an operating key, a touchscreen or a touch sensor and inputs a signal corresponding to a user operation to the controller 151.

The display module 153 is provided with a liquid crystal display or an organic EL display and displays a character or an image depending on an operation of the application by the controller 151.

The voice input/output module 154 is provided with a speaker and a microphone, and inputs/outputs a talking voice of a voice call through the wireless telephone communication module 155 and outputs a voice and a music in music contents and animation contents.

The network communication module 155 carries out a voice communication and a packet communication through a base station. For example, in the case in which a voice is transmitted through the voice communication, data obtained by executing a signal processing such as coding or error control over voice data of a voice received from the microphone of the voice input/output module 154 are converted into an electric wave and the electric wave is transmitted to the base station. For a receiving voice, moreover, an electric wave is received from the base station and is converted into an electric signal, and a signal processing such as decoding or error correction is then executed and a voice is output from the speaker of the voice input/output module 154.

The storage module 156 is provided with a Read Only Memory (ROM) for storing a processing program for a processing to be executed by the controller 151 and necessary data for the processing, a hard disk, a nonvolatile memory, a data base, and a Random Access Memory (RAM) for temporarily storing data to be used when a main controller 121 executes a processing.

The Bluetooth communication module 157 is provided with a Bluetooth communication module, etc., and is operated by the controller 151 to enable a voice call by a hands-free apparatus through Hands-Free Profile (HFP) and can transfer audio data to a counterpart apparatus without using an audio cable through an Advanced Audio Distribution Profile (A2DP).

The NFC communication module 158 is provided with an NFC communication module, etc., and establishes an NFC communication with a counterpart apparatus and communicates data through the NFC communication with the counterpart apparatus based on an instruction given from the controller 151.

As a terminal capable of carrying out a Bluetooth communication with the mobile phone 101 having the configuration described above, a headset and an on-vehicle apparatus (for example, a car navigation system) are assumed, for instance. In a vehicle provided with the on-vehicle apparatus, an NFC module for unlocking/locking doors is installed in the driver's door, and a Bluetooth address of the on-vehicle apparatus is stored in a storing device of the NFC module.

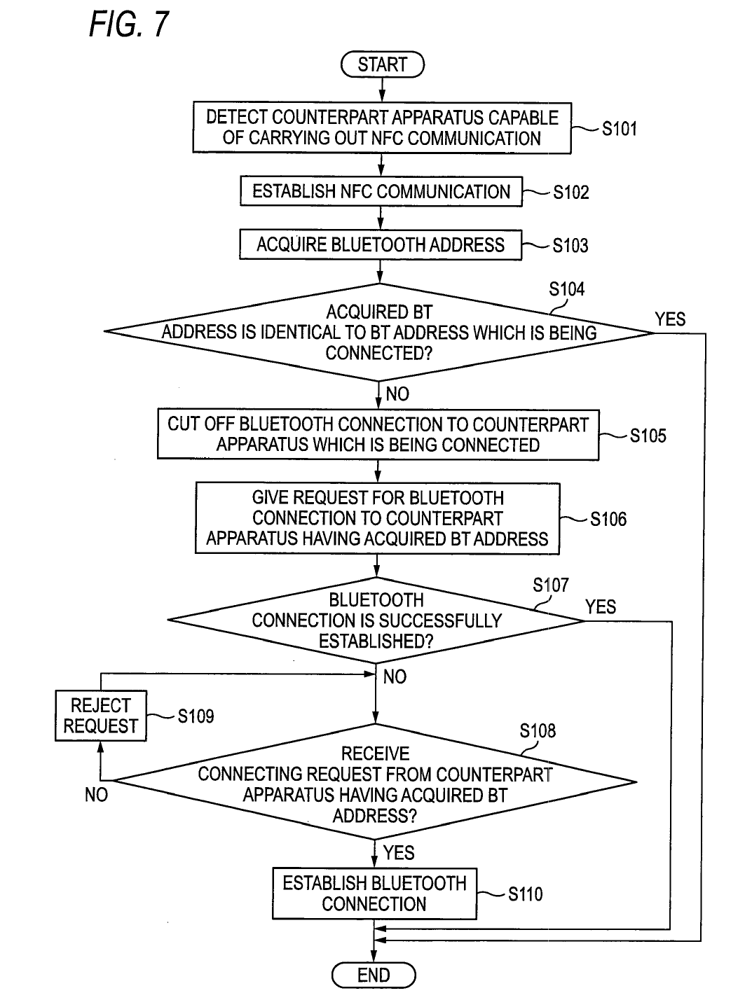

FIG. 7 is a flowchart showing a processing to be executed by the controller 151. The processing is executed in a case that the mobile phone 101 is caused to approach a position in which an NFC communication with another apparatus (for example, the NFC module) capable of carrying out the NFC communication when the mobile phone 101 is connected to a certain apparatus (for example, the headset) with a Bluetooth connection.

When the mobile phone 101 is caused to approach a position in which a communication with a second counterpart apparatus capable of carrying out the NFC communication can be performed in a state of the Bluetooth connection to a first counterpart apparatus (Step S101), an authentication is made together with the second counterpart apparatus to establish a connection of the NFC communication (Step S102). The NFC communications of the mobile phone 101 and the second counterpart apparatus may be carried out in a state in which one of the NFC communications of the mobile phone 101 and the second counterpart apparatus is set to be a functionally main part and the other is set to be a functionally sub part or a state in which the NFC communications of the mobile phone 101 and the second counterpart apparatus are functionally equal to each other and can mutually carry out the communication. A Bluetooth address of a Bluetooth device corresponding to the second counterpart apparatus is acquired through the established NFC communication (Step S103).

In order to acquire the Bluetooth address, it is possible to propose a method of receiving the Bluetooth address by using a handover function determined in the specification (Connection Handover 1.1) related to a connection handover released by NFC Forum™. Moreover, it is also possible to propose a method of matching and previously storing information for identifying the NFC module and the Bluetooth address in the storage module 156 of the mobile phone 101 and receiving the Bluetooth address stored in the storage module 156 corresponding to the information for identifying the NFC module which is given through the NFC communication. Only one of the two Bluetooth address receiving methods may be used (only the reception of the Bluetooth address through the handover function is always carried out or only the reception of the Bluetooth address using the previously stored matching is always carried out) or one of the two Bluetooth address may be used preferentially (the Bluetooth address is used by utilizing the previously stored matching when the Bluetooth address cannot be acquired through the handover function or the Bluetooth address acquired through the handover function is used when the Bluetooth address cannot be acquired by using the previously stored matching).

Then, the controller 151 decides whether or not the Bluetooth address acquired at Step S103 is coincident with a Bluetooth address of a counterpart apparatus which is being connected through the Bluetooth (Step S104). The Bluetooth connection to a counterpart apparatus having the acquired Bluetooth address is established if there is no counterpart apparatus which is being connected through the Bluetooth at Step S103, which is not shown.

If the acquired Bluetooth address is coincident with the Bluetooth address of the counterpart apparatus which is being connected through the Bluetooth (Yes in Step S104), a connection to the first counterpart apparatus which is being connected through the Bluetooth is maintained. If the acquired Bluetooth address is not coincident with the Bluetooth address of the counterpart apparatus which is being connected through the Bluetooth (No in Step S104), it is decided that there is given a request for the Bluetooth connection to a separate apparatus from the first counterpart apparatus which is being connected through the Bluetooth. Therefore, a request for releasing the Bluetooth connection to the first counterpart apparatus which is being connected is transmitted through the Bluetooth communication, and the Bluetooth connection to the first counterpart apparatus is released (Step S105).

After the Bluetooth connection is completely released at Step S105, thereafter, there is given a request for the Bluetooth connection to the counterpart apparatus having the Bluetooth address acquired at Step S103 (Step S106). If the Bluetooth address is acquired through the handover function at Step S103, it is possible to acquire security information such as a hash or a random value which is to be used for pairing in addition to the Bluetooth address from the counterpart apparatus through the NFC communication. By using the information, it is possible to establish the Bluetooth connection.

Even if the request for the Bluetooth connection to the counterpart apparatus having the acquired Bluetooth address is given at Step S106, the Bluetooth connection cannot be established in some cases. For example, in the case in which the NFC module is supposed as the second counterpart apparatus at Step S103, the Bluetooth function of an on-vehicle apparatus having the Bluetooth address acquired from the NFC module is not set into an ON state or a power supply of the on-vehicle apparatus itself is not set into the ON state. If the Bluetooth connection is not successfully established (No in Step S107), there is carried out setting to a mode for accepting only a connecting request given from the counterpart apparatus having the Bluetooth address acquired at Step S103.

By setting the mode, it is possible to eliminate an unnecessary connection from a separate apparatus from the counterpart apparatus having the Bluetooth address acquired at Step S103. Thus, it is possible to reliably establish the Bluetooth connection to the counterpart apparatus having the Bluetooth address acquired at Step S103. When there is carried out the setting to the mode for accepting only the connecting request given from the counterpart apparatus having the Bluetooth address acquired at Step S103 (No in Step S108), there is rejected a connecting request given from a counterpart apparatus other than the counterpart apparatus having the Bluetooth address acquired at Step S103 (Step S109).

The rejection of the connecting request includes the case in which the Bluetooth connection is not established even if the connecting request is acquired from the apparatus other than the counterpart apparatus having the Bluetooth address acquired at Step S103, and furthermore, the case in which a disconnection is carried out before a service is started even if the Bluetooth connection is established when the connecting request is received from the apparatus other than the counterpart apparatus having the Bluetooth address acquired at Step S103.

If the connecting request is accepted from the counterpart apparatus having the Bluetooth address acquired at Step S103 in the mode for accepting only the connecting request given from the counterpart apparatus (Yes in Step S108), the Bluetooth connection to the counterpart apparatus is established (Step S110) and there is cancelled the mode for accepting only the connecting request given from the counterpart apparatus having the Bluetooth address acquired at the Step S103.

The mode for accepting only the connecting request given from the counterpart apparatus having the Bluetooth address acquired at Step S103 may be cancelled by approaching a position in which the NFC communication can be carried out again with the second counterpart apparatus which is detected at Step S101 during the mode setting and can perform the NFC communication and thereby establishing the NFC connection. Moreover, it is also possible to cancel the mode by approaching a position in which the NFC communication can be carried out with a separate counterpart apparatus capable of performing the NFC communication from the second counterpart apparatus detected at Step S101 during the mode setting and thereby establishing the NFC connection. Alternatively, it is also possible to cancel the mode when calculating an elapsed time after the mode setting through timer means (not shown) possessed by the mobile phone 101 and detecting that the elapsed time exceeds a given time.

By the cancellation of the mode for accepting only the connecting request given from the counterpart apparatus having the Bluetooth address acquired at Step S103, thus, there is not permanently maintained a state in which an unnecessary connection is eliminated from the separate counterpart apparatus from the counterpart apparatus having the Bluetooth address acquired at Step S103. For example, in the case in which a door of a car is to be unlocked and locked depending on a communication with the NFC module installed in the door and the Bluetooth connection to an on-vehicle apparatus provided in the car is to be carried out when unlocking the door (in other words, when predicting to get in the car), the Bluetooth connection to the on-vehicle apparatus cannot be established if a power supply of the on-vehicle apparatus is not ON when the door is unlocked, and there is set the mode for accepting only the connecting request from the on-vehicle apparatus. However, the Bluetooth connection to the on-vehicle apparatus is not required when getting out of the car. By cancelling the mode for accepting only the connecting request from the on-vehicle apparatus depending on the execution of the NFC communication with the NFC module to carry out the door locking, therefore, it is possible to accept the Bluetooth connection from another counterpart apparatus (for example, a headset).

Through the processing described above, in the case in which switching into the Bluetooth connection to the second counterpart apparatus is to be carried out when the connection to the first counterpart apparatus through the Bluetooth is established, a user can release the Bluetooth connection to the first counterpart apparatus and can establish the Bluetooth connection to the second counterpart apparatus by only a processing having a single step for approaching a distance at which the NFC communication with the second counterpart apparatus can be performed. In other words, it is possible to rapidly switch a counterpart apparatus to be a Bluetooth connecting destination by omitting a time and labor of the user.

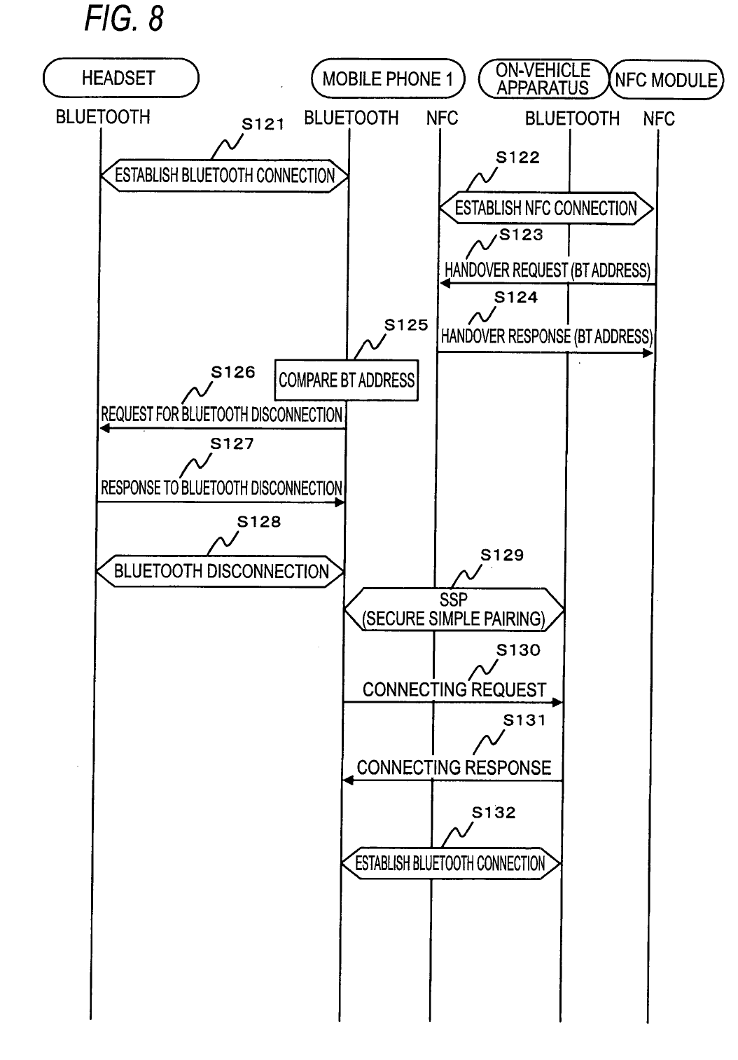

FIG. 8 is a sequence diagram showing a specific processing for switching a Bluetooth connecting destination into an on-vehicle apparatus when the mobile phone 101 for executing the processing shown in the flowchart of FIG. 7 is connected to a headset through the Bluetooth.

First of all, the mobile phone 101 is set into a state in which the Bluetooth connection to the headset is established (Step S121). In this state, when it is detected that the mobile phone 101 is caused to approach a distance at which an NFC communication with an NFC module for door unlocking/locking installed in a car can be carried out, an NFC connection between the mobile phone 101 and the NFC module is established (Step S122). After the NFC connection is established, the NFC module makes an authentication for the mobile phone 101 to unlock the door of the car, which is not shown. When the NFC communication between the mobile phone 101 and the NFC module is established at Step S122, a handover request is transmitted from the NFC module to the mobile phone 101 (Step S123).

Referring to the handover request, there is given security information such as a Bluetooth address of an on-vehicle apparatus corresponding to the NFC module and a hash or a random value which is to be used for pairing. The NFC communication module 158 of the mobile phone 101 receives the handover request and gives the handover request to the NFC controller 151b. Then, the NFC communication module 158 transmits, to the NFC module, a handover response to be a response to the handover request based on control of the NFC controller 151b (Step S124). For the handover response, there can be supposed the case in which the Bluetooth address of the mobile phone 101 is included and the case in which it is not included.

The Bluetooth controller 151a of the mobile phone 101 detects that the Bluetooth address of the on-vehicle apparatus given from the NFC controller 151b is not coincident with a Bluetooth address of a counterpart apparatus (a headset) which is being connected through the Bluetooth (Step S125). Therefore, the Bluetooth controller 151a transmits a request for a Bluetooth disconnection to the headset by using the Bluetooth communication module 157 (Step S126), receives a Bluetooth disconnecting response to the request for a Bluetooth disconnection from the headset (Step S127), and releases the Bluetooth connection to the headset (Step S128).

Then, the Bluetooth controller 151a of the mobile phone 101 carries out an authentication processing through a Secure Simple Pairing (SSP) method by using the given security information together with the counterpart apparatus (the on-vehicle apparatus) having the Bluetooth address given in response to the handover request sent from the NFC module (Step S129), transmits a request for establishing a Bluetooth connection to the on-vehicle apparatus when completing the authentication processing (Step S130), and receives a response to the request for establishing the connection from the on-vehicle apparatus (Step S131). Consequently, the Bluetooth connection between the mobile phone 101 and the on-vehicle apparatus is established (Step S132).

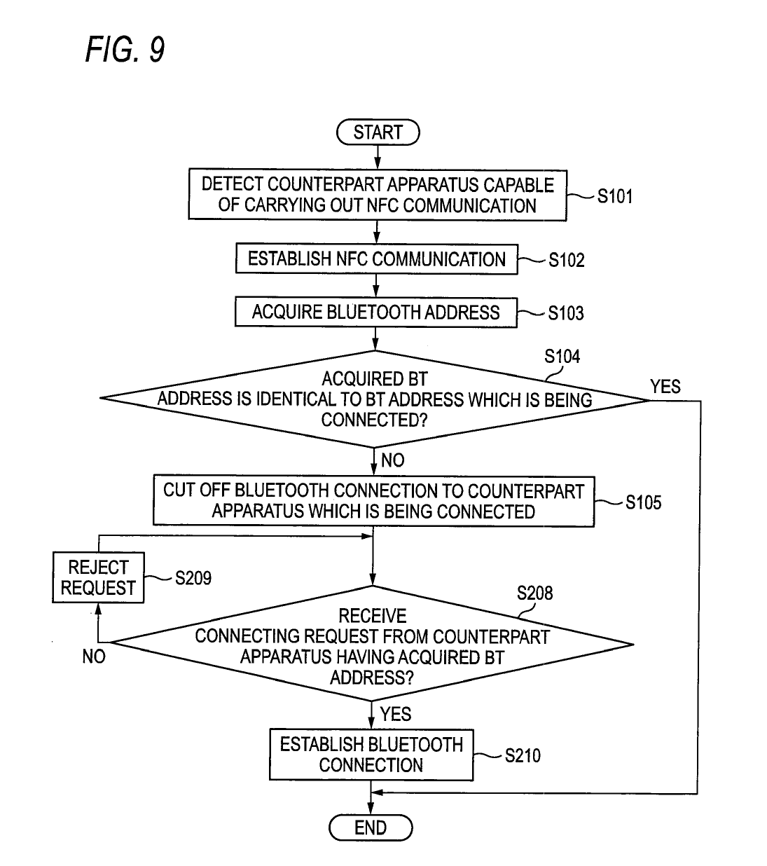

FIG. 9 is a flowchart showing a second processing to be executed when the mobile phone 101 is caused to approach a position in which an NFC communication with another counterpart apparatus (an NFC module) capable of carrying out the NFC communication can be performed in the Bluetooth connection to a certain counterpart apparatus (a headset). The same processing steps shown in FIG. 9 as those in FIG. 7 have the same symbols. While the request for establishing the Bluetooth connection is given to the counterpart apparatus having the Bluetooth address acquired by the mobile phone 101 at Step S106 in the processing of the mobile phone 101 described with reference to FIG. 7, the request for establishing the Bluetooth connection is not given from the mobile phone 101 in the processing of the mobile phone 101 shown in FIG. 9.

In other words, if a Bluetooth address acquired through an NFC communication from a counterpart apparatus establishing an NFC connection is not coincident with a Bluetooth address of a apparatus which is being connected (No in Step S104), the Bluetooth connection to the apparatus which is being connected is released (Step S105) and a request for the Bluetooth connection is then waited to be given from the counterpart apparatus. If a connecting request is not given from the counterpart apparatus having the Bluetooth address acquired through the NFC communication (No in Step S208), the request is rejected (Step S209). If the connecting request is given from the counterpart apparatus having the Bluetooth address acquired through the NFC communication, a Bluetooth connection to the counterpart apparatus is established (Step S210).

By approaching a position in which the NFC communication can be carried out again with a second counterpart apparatus capable of performing the NFC communication detected at Step S101 and establishing the NFC connection, it is also possible to cancel the state in which the connecting request is accepted from the counterpart apparatus having the Bluetooth address acquired through the NFC communication at Step S208 and the connecting request given from another apparatus is rejected. By approaching a position in which the NFC communication can be carried out with a separate counterpart apparatus capable of performing the NFC communication from the second counterpart apparatus detected at Step S101 and establishing the NFC connection, moreover, it is also possible to cancel the state. Alternatively, it is also possible to cancel the state when calculating an elapsed time after the acceptance of the connecting request from the counterpart apparatus having the Bluetooth address acquired through the NFC communication is started to be waited and detecting that the elapsed time exceeds a given time.

Although the description has been given on the assumption that the mobile phone 101 can carry out the NFC communication and the Bluetooth communication, the second embodiment is not limited to the NFC communication and the Bluetooth communication but the NFC communication may be an infrared communication and the Bluetooth communication may be wireless LAN. It is sufficient that identifying information about a second communication can be transmitted through a first communication. If it is easy for a user to enable an establishment of a connection of the first communication in the same manner as the NFC communication and a communicating speed of the second communication is higher than that of the first communication, furthermore, information about a connection of the second communication is simply communicated through the first communication and data are communicated through the second communication. Therefore, the user can establish the connection by a simple operation, and furthermore, a high speed data communication can be carried out.

Although the description has been given on the assumption that the communication with the headset, the on-vehicle apparatus or the NFC module is carried out, moreover, the embodiment is not limited thereto. In addition, it is not necessary to cause the on-vehicle apparatus and the NFC module to be different from each other. For example, it is also possible to receive, from a PC capable of carrying out an NFC communication and a Bluetooth communication, a notice of a Bluetooth address of through the NFC communication with the PC, to compare the given Bluetooth address with a Bluetooth address of an apparatus which is being connected through Bluetooth, and to release the Bluetooth connection to the apparatus which is being connected if the Bluetooth address are not coincident with each other, thereby establishing the Bluetooth connection to the PC.

By employing the configurations according to the embodiments described above, it is possible to provide a wireless communication apparatus capable of easily disconnecting and connecting a wireless communication.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A wireless communication apparatus comprising:
a first communication module configured to communicate with a counterpart apparatus;
a plurality of other communication modules configured to take over a communication with the counterpart apparatus from the first communication module;
a power state storage module configured to store power states of the plurality of other communication modules; and
a controller configured to confirm the power states when one of the plurality of other communication modules takes over the communication from the first communication module,
wherein the controller is configured to transmit, to the counterpart apparatus through the first communication module, a request for handing over the communication to the one of the plurality of other communication modules if the power state of the one of the plurality of other communication modules is ON.

2. The wireless communication apparatus according to claim 1 further comprising:
an operation module configured to accept an operation from a user,
wherein the controller is configured to confirm a power state of a third communication module included in the plurality of other communication modules, and
wherein the controller is configured to transmit, to the counterpart apparatus through the first communication module, a request for handing over the communication to the third communication module if the power state of the third communication module is ON, and to transmit, to the counterpart apparatus through the first communication module, a request for handing over the communication to a fourth communication module which is selected by the user through the operation module if the power state of the third communication module is OFF.

3. The wireless communication apparatus according to claim 1 further comprising:
an identifying information storage module configured to store first identifying information about the plurality of other communication modules by matching the first identifying information with second identifying information about applications to be executed by the wireless communication apparatus,
wherein the plurality of other communication modules include a fifth communication module matched with one of the applications which is being executed, and
wherein the controller is configured to transmit, to the counterpart apparatus through the first communication module, a request for handing over the communication to the fifth communication module when the power states of the plurality of other communication modules are ON.

4. A wireless communication apparatus comprising:
a first wireless communication module configured to perform a first wireless communication;
a second wireless communication module configured to perform a second wireless communication which is different from the first wireless communication; and
a controller configured to communicate with a second counterpart apparatus by the first wireless communication while the wireless communication apparatus is connected with a first counterpart apparatus by the second wireless communication, and to receive second identifying information about the second wireless communication corresponding to one of the second counterpart apparatus and a third counterpart apparatus,
wherein the controller is configured to release a connection of the second wireless communication to the first counterpart apparatus if the second identifying information is different from first identifying information about the second wireless communication of the first counterpart apparatus.

5. The wireless communication apparatus according to claim 4, wherein the controller is configured to connect the wireless communication apparatus to the second counterpart apparatus by the second wireless communication after release the connection of the second wireless communication to the first counterpart apparatus.

6. The wireless communication apparatus according to claim 5, wherein the controller is configured to reject a connecting request given from a separate counterpart apparatus from the second counterpart apparatus if a connection of the second wireless communication to the second counterpart apparatus fails.

7. The wireless communication apparatus according to claim 4, wherein, after the controller releases the connection of the second wireless communication to the first counterpart apparatus, the controller is configured to accept a connecting request from the second counterpart apparatus and to reject a connecting request given from a separate counterpart apparatus from the second counterpart apparatus.

8. The wireless communication apparatus according to claim 6, wherein, in a state in which there is rejected the connecting request given from the separate counterpart apparatus, the controller is configured to accept a subsequent connecting request given from the separate counterpart apparatus when the first wireless communication with one of the second counterpart apparatus and the separate counterpart apparatus is performed by the first wireless communication module.

9. The wireless communication apparatus according to claim 7, wherein, in a state in which there is rejected the connecting request given from the separate counterpart apparatus, the controller is configured to accept a subsequent connecting request given from the separate counterpart apparatus when the first wireless communication with one of the second counterpart apparatus and the separate counterpart apparatus is performed by the first wireless communication module.

10. The wireless communication apparatus according to claim 6, further comprising:
a timer configured to measure an elapsed time after setting a state in which there is rejected the connecting request given from the separate counterpart apparatus,
wherein the controller is configured to accept a subsequent connecting request given from the separate counterpart apparatus when the elapsed time obtained by the timer exceeds a given time.

11. The wireless communication apparatus according to claim 7, further comprising:
a timer configured to measure an elapsed time after setting a state in which there is rejected the connecting request given from the separate counterpart apparatus,
wherein the controller is configured to accept a subsequent connecting request given from the separate counterpart apparatus when the elapsed time obtained by the timer exceeds a given time.

12. A wireless communication apparatus comprising:
a first wireless communication module configured to perform a first wireless communication;
a second wireless communication module configured to perform a second wireless communication which is different from the first wireless communication;
a storage module configured to store second identifying information about the second wireless communication by matching the second identifying information with first identifying information about the first wireless communication of a second counterpart apparatus; and
a controller configured to communicate with the second counterpart apparatus through the first wireless communication module while the wireless communication apparatus is connected with a first counterpart apparatus by the second wireless communication, and to receive the second identifying information of the second counterpart apparatus,
wherein the controller is configured to release a connection of the second wireless communication to the first counterpart apparatus if the second identifying information is different from third identifying information about the second wireless communication of the first counterpart apparatus.

13. The wireless communication apparatus according to claim 12, wherein the controller is configured to connect the wireless communication apparatus to the second counterpart apparatus by the second wireless communication after releasing the connection of the second wireless communication to the first counterpart apparatus.

14. The wireless communication apparatus according to claim 13, wherein the controller is configured to reject a connecting request given from a separate counterpart apparatus from the second counterpart apparatus if a connection of the second wireless communication to the second counterpart apparatus fails.

15. The wireless communication apparatus according to claim 13, wherein, after the controller releases the connection of the second wireless communication to the first counterpart apparatus, the controller is configured to accept a connecting request from the second counterpart apparatus and to reject a connecting request given from a separate counterpart apparatus from the second counterpart apparatus.

16. The wireless communication apparatus according to claim 14, wherein, in a state in which there is rejected the connecting request given from the separate counterpart apparatus, the controller is configured to accept a subsequent connecting request given from the separate counterpart apparatus when the first wireless communication with one of the second counterpart apparatus and the separate counterpart apparatus is performed by the first wireless communication module.

17. The wireless communication apparatus according to claim 15, wherein, in a state in which there is rejected the connecting request given from the separate counterpart apparatus, the controller is configured to accept a subsequent connecting request given from the separate counterpart apparatus when the first wireless communication with one of the second counterpart apparatus and the separate counterpart apparatus is performed by the first wireless communication module.

18. The wireless communication apparatus according to claim 14, further comprising:
a timer configured to measure an elapsed time after setting a state in which there is rejected the connecting request given from the separate counterpart apparatus,
wherein the controller is configured to accept a subsequent connecting request given from the separate counterpart apparatus when the elapsed time obtained by the timer exceeds a given time.

19. The wireless communication apparatus according to claim 15, further comprising:
a timer configured to measure an elapsed time after setting a state in which there is rejected the connecting request given from the separate counterpart apparatus,
wherein the controller is configured to accept a subsequent connecting request given from the separate counterpart apparatus when the elapsed time obtained by the timer exceeds a given time.
